(19) United States
(12) Patent Application Publication
(10) Pub. No.: US 2007/0168440 A1
(43) Pub. Date: Jul. 19, 2007

(54) Bandwidth-saving discovery on dual-stack upnp devices

(75) Inventor: Boris Cobelens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/578,064

(22) PCT Filed: Oct. 22, 2004
(86) PCT No.: PCT/IB04/52180

§ 371 Date: May 2, 2006

(30) Foreign Application Priority Data
Nov. 6, 2003 (EP) 03104110.6

(51) Int. Cl. G06F 15/16

(52) U.S. Cl. 709/207

(57) ABSTRACT

A dual-stack UPnP-compliant device supports both IPv4 and IPv6. The device uses the SSDP protocol for discovery based on IP multicasting. The device sends SSDP query packets that comprise an indication that the device supports both IPv4 and IPv6. The indication is accommodated in an option field of the packet. A responding dual-stack device responds either to the first query packet that arrives or responds to only the query packet of IPv6.

### FIELD OF THE INVENTION

The invention relates to an electronic device with an operational mode for multicasting a query packet on a data network that supports multiple data communication protocols. The invention also relates to configuration software and to methods of enabling to configure electronic devices.

### BACKGROUND ART

Universal Plug and Play (UPnP) is an industry-wide ongoing development for an open network architecture that is designed to enable simple, ad hoc communication among distributed devices and software applications from multiple vendors. UPnP leverages Internet technology and extends it for use in non-supervised home networks. UPnP aims at controlling home appliances, including home automation, audio/video, printers, smart phones, etc. UPnP distinguishes between Control Points (CPs) and controlled devices (CDs). CPs comprise, e.g., browsers running on PCs, wireless pads, etc., that enable a user to access the functionality provided by controlled devices.

UPnP defines protocols for discovery and control of devices by CPs. UPnP does not define a streaming mechanism for use by AudioVideo devices. Some of the discovery and control protocols are part of the UPnP specification while others are separately standardized by the IETF (Internet Engineering Task Force).

Interaction between CPs and devices is based on the Internet protocol (IP). However, UPnP allows non-IP devices to be proxied by a software component running on IP-compliant devices. Such a component, called Controlled Device (CD) proxy, is responsible for translation and forwarding of UPnP interactions to the proxied device.

A UPnP device has a hierarchy of sub-devices with at the lowest level services. Both devices and services have standardized types. A device type determines the sub-devices or services that it is allowed to contain. A service type defines actions and state variables that a service is allowed to contain. State variables model the state of the device, a CP can invoked actions in order to change that state. The description of the state variables and the actions is called the SCP (Service Control Protocol). A UPnP device provides a description of itself in the form of an XML document. This document contains, among other things, the service types that it supports. Optionally, a device may have a presentation server for direct UI control by a CP.

UPnP relies currently on AutoIP, which provides a means for an IP device to get a unique address in the absence of a DHCP server. UPnP defines a discovery protocol, based on UDP multicast, called SSDP (Simple Service Discovery Protocol). SSDP is based on devices periodically multicasting announcements of the services that they provide. An announcement contains a URL to which service actions are to be sent: the control server. In addition to that, CPs may query the UPnP network for particular device or services types or instances.

UPnP relies on GENA (Generic Event Notification Architecture) to define a state variable subscription and change notification mechanism based on TCP.

After a CP has detected a service it wants to use (via SSDP), it controls the service by sending SCP actions to the control server URL or querying for state variables. Actions are sent using HTTP POST messages. The body of such a message is defined by the SOAP (Simple Object Access Protocol) standard. SOAP defines a remote procedure call mechanism based on XML.

As mentioned above, UPnP is based on the IP. Under the IP, packets are routed from a source to a destination. Routers forward the packets from incoming network interfaces to outbound interfaces according to routing tables. The routing tables typically maintain the next-hop (outbound interface) information for each destination IP address, according to the number of networks to which that IP address is connected. The network number is derived from the IP address by masking off some of the low-order bits. Thus, the IP address typically carries with it information that specifies the IP node's point of attachment.

The exponential growth of the Internet has led to a shortage of IP addresses. The currently used version of IP, referred to as IP version 4 or IPv4, uses 32 bits to designate an IP address. The address space spanned by 32 bits has about 4.3*10⁹ different addresses. The number of addresses needed is expected to become exhausted well before 2010.

IP version 6, or IPv6, has been proposed to find a solution for the address deficiency in IPv4. The new IPv6 uses addresses of 128 bits wide, making available a number of roughly 3.4*10³⁸ different addresses. A consequence is that the address bottleneck will not exist anymore so that each piece of equipment of any user could be made IP-compliant by giving it a unique IPv6 address. In addition to solving the addresses problem, IPv6 also adds many improvements to IPv4 in areas such as routing and network auto-configuration. It is expected that IPv6 will gradually replace IPv4, with the two co-existing for some time during this transition period.

UPnP was originally designed for IPv4. As for home networking IPv6 is going to play a major role, using UPnP on top of IPv6, and especially IPv4/IPv6 dual stacks, gets serious attention. Dual stack systems are going to be important for years to come in view of compatibility with IPv4 devices.

An approach to IPv4/IPv6 environments is described in, e.g., U.S. Pat. Appl. Publ. 20030051052 (attorney docket US 018150) of U.S. Ser. No. 09/952,095 filed Sep. 13, 2001, for Eugene Shteyn and Thomas Chiu for ADDRESSING SCHEME FOR WIRELESS CLIENTS, the content of which is incorporated herein by reference. This document relates to enabling a wireless client to communicate with a data network via an access point. The access point assigns an address to the client, based on the network address of the access point itself and a unique identifier (e.g., MAC) of the client. The unique identifier is used to generate a port number that gets assigned to the client, e.g., for a certain duration. In this manner, an interruption in the wireless communication avoids assigning a new port number to the same client, which would lead to address collisions. This unique identifier approach has also advantages for the future version of IP addressing, e.g., IPv6. The unique identifier can be used to generate a unique IPv6 style number. Then, in a legacy IPv4 network or for security reasons, the number can be used to generate a PORT number. To ensure future (IPv6) compatibility, the access point can internally represent all clients as having IPv6 addresses. Therefore, when the network is upgraded to IPv6, the access points will use the IPv6 addressing scheme directly, bypassing the network address translation (NAT). Also, in a mixed IPv4 IPv6 environment, the access point can flexibly use both addressing schemes, depending on the client or network configuration.

Recommendations on how to modify UPnP for IPv6 and dual stacks are disclosed in “UPnP FORUM, UPnP Device Architecture V1.0, Annex A—IP Version 6 Support” of 2002. This document addresses the issue as follows. UPnP uses the SSDP protocol for service discovery, as mentioned above. SSDP is based on IP multicasting for queries and IP unicasting for query replies. The proposed way of doing queries from dual-stack devices is to send out the same query packet on both IPv4 and IPv6 connections. This way IPv4 -only, IPv6 -only and dual-stack devices will receive the query. According to the protocol, each query packet must be responded to. Consequently, dual-stack devices will give double response to queries sent by other dual-stack devices.

### SUMMARY OF THE INVENTION

The inventor has realized that a drawback of the approach advocated in the UPnP FORUM document is that bandwidth and resources are being wasted, thereby limiting the scalability of UPnP in dual-stack environments. This problem is especially significant in wireless Ethernet networks or Bluetooth networks with limited bandwidth. In other words, networks with dual-stack devices as proposed by above document operate less efficiently than do IPv4-only or IPv6-only networks. As for compatibility with legacy devices, dual-stack devices are essential. Note that dual-stack devices are going to be around for a long time in view of supporting legacy devices. Accordingly, there is a serious problem as specified above, if they are less attractive to use.

Therefore, the inventor proposes to use, instead, an addition to SSDP query packets sent by dual-stack devices to indicate that they operate using both IPv4 and IPv6. When an IPv4-only device or an IPv6-only device receives the query packets, the packets get parsed, and what cannot be interpreted by the relevant device is ignored. A responding dual-stack device has following options to handle such a query. As a first option, the device responds only to the instance of the query first to arrive through either IPv4 or IPv6. This requires that the responding device keep track of what queries it has handled. Note that the IPv4 and IPv6 query packets of the same query both enable to identify the same query. As known, UPnP uses the Universal Unique Identifier (UUID) in order to be able to identify devices. Queries from a particular device can be recognized as such, e.g., by including the relevant UUID in the OPT field. The OPT field is an extension of the HTTP format that allows to use proprietary header fields in the HTTP header. As a second option, the device prefers IPv6, which is more likely because of the advantages IPv6 offers, and ignores dual-stack query packets received through IPv4. As SSDP packets are in HTTP format, it is not difficult to add information to packets without violating the protocol. A simple way to do this is by using the OPT field that is documented in RFC 2774.

Advantages are manifold. Network-bandwidth usage decreases. Responding dual-stack devices will send a single reply instead of two. Fewer packets also mean less HTTP parsing. This might be significant for devices with limited resources. The extended SSDP query packets are fully compatible with default SSDP implementations and the SSDP protocol needs no modification. This means that there are no compatibility issues. As a result, dual-stack UPnP devices in this invention reduce bandwidth usage while remaining compatible with other IPv4-only, IPv6-only and dual-stack UPnP-compliant devices.

This invention can be generalized beyond UPnP for similar situations in which multicast queries are sent out through multiple channels on a heterogeneous network.

### BRIEF DESCRIPTION OF THE DRAWING

The invention is explained in further detail below, by way of example, and with reference to the accompanying drawing wherein:

FIGS. 1-3 are diagrams illustrating conventional scenarios for multicast querying; and

FIGS. 4-6 are diagrams illustrating scenarios for multicast querying in the invention.

Throughout the drawing, same reference numerals indicate similar or corresponding features.

### DETAILED EMBODIMENTS

An instance of the invention relates to a device for use on a heterogeneous data network that supports multiple data communication protocols. Such a heterogeneous network is a single physical network such as Ethernet, made up of multiple logical networks, e.g., an IPv4 network and an IPv6 network. The device has an operational mode for multicasting on the data network respective query packets that use respective ones of the multiple protocols. In the invention, at least a specific one of the respective query packets includes an indication representative of the device supporting the multiple protocols. For example, the device comprises a UPnP-compliant component for querying the network based on IP multicasting. The protocols comprise, e.g., IPv4 and IPv6. The UPnP component is configured to send the specific query packet with the indication that the component supports both IPv4 and IPv6. Preferably, the specific query packet comprises an SSDP packet and the indication is accommodated in an OPT field of the SSDP packet.

Another instance of the invention relates to an electronic device for use on a data network that supports multiple data communication protocols. The device supports the multiple protocols and has an operational mode for receiving, via the network, respective query packets using respective ones of the multiple protocols. At least a specific one of the query packets includes an indication representative of a source of the query packets supporting the multiple protocols. The device responds to only a single one of the query packets using a single one of the protocols in dependence of the indication. For example, the device responds to only the single query packet that is the first to arrive. Alternatively, the device responds to only the single query packet that uses a specific one of the protocols. The device may comprise a UPnP-compliant component, and the protocols include IPv4 and IPv6. The device may have been configured to respond to only the query packet using IPv6.

Another instance of the invention relates to software for configuring an electronic device for use on a data network that supports multiple data communication protocols. The device is configured for multicasting on the data network respective query packets using respective ones of the multiple protocols. The software is operative to configure the device for including in at least a specific one of the respective query packets an indication representative of the device supporting the multiple protocols. For example, the device comprises a UPnP-compliant component for querying the network based on IP multicasting, and the protocols include IPv4 and IPv6. The software is then operative to configure the component for sending the specific query packet with the indication that the component supports both IPv4 and IPv6. In this example, the specific query packet comprises an SSDP packet. The software then configures the component so as to accommodate the indication in an OPT field of the SSDP packet.

Yet another instance of the invention relates to software for configuring an electronic device for use on a data network that supports multiple data communication protocols. The device is configured to support the multiple protocols and has an operational mode for receiving via the network respective query packets using respective ones of the multiple protocols. At least a specific one of the query packets include an indication representative of a source of the query packets supporting the multiple protocols. The software is operative to configure the device for responding to only a single one of the query packets using a single one of the protocols in dependence of the indication. For example, the software configures the device to respond to only the single query packet that is the first to arrive. Alternatively, the software configures the device to respond to only the single query packet that uses a specific one of the protocols. In a particular embodiment of the invention, the device comprises a UPnP-compliant component, and the protocols include IPv4 and IPv6. The software then configures the device to respond to only the single query packet using IPv6.

A further instance of the invention relates to a method of enabling to configure an electronic device for use on a data network that supports multiple data communication protocols. Such a method is relevant to, e.g., service providers to whom the configuring of, e.g., home network equipment can be delegated. Within this context, see, e.g., U.S. Ser. No. 09/519,546 (attorney docket US 000014) filed Mar. 6, 2000, for Erik Ekkel et al., for

PERSONALIZING CE EQUIPMENT CONFIGURATION AT SERVER VIA WEB-ENABLED DEVICE, incorporated herein by reference and published as WO0154406. Aforesaid document relates to facilitating the configuring of consumer electronics (CE) equipment by the consumer by means of delegating the configuring to an application server on the Internet. The consumer enters relevant information in a specific interactive Web page through a suitable user-interface of an Internet-enabled device, such as a PC or set-top box or digital cellphone. The application server generates the control data based on the information items entered and downloads the control data to the CE equipment itself or to the Internet-enabled device. The method of the current invention applies to the device that is configured for multicasting on the data network respective query packets using respective ones of the multiple protocols. The method comprises enabling to configure the device for including in at least a specific one of the respective query packets an indication representative of the device supporting the multiple protocols. The device comprises, e.g., a UPnP-compliant component for querying the network based on IP multicasting, and the protocols include IPv4 and IPv6. The method comprises enabling to configure the component to send the specific query packet with the indication that the component supports both IPv4 and IPv6. For example, the specific query packet comprises an SSDP packet, and the method comprises enabling to configure the component so as to accommodate the indication in an OPT field of the SSDP packet.

Yet another instance of the invention relates to a method of enabling to configure an electronic device for use on a data network that supports multiple data communication protocols. Such method is relevant to service providers, e.g., as discussed above. The device is configured to support the multiple protocols. The device has an operational mode for receiving via the network respective query packets using respective ones of the multiple protocols. At least a specific one of the query packets include an indication representative of a source of the query packets supporting the multiple protocols. The method comprises enabling to configure the device for responding to only a single one of the query packets using a single one of the protocols in dependence of the indication. For example, the method comprises enabling to configure the device to respond to only the single query packet that is the first to arrive. Alternatively, the method comprises enabling to configure the device to respond to only the single query packet that uses a specific one of the protocols. For example, the device comprises a UPnP-compliant component, and the protocols comprise IPv4 and IPv6. The method may comprise enabling to configure the device to respond to only the single query packet using IPv6.

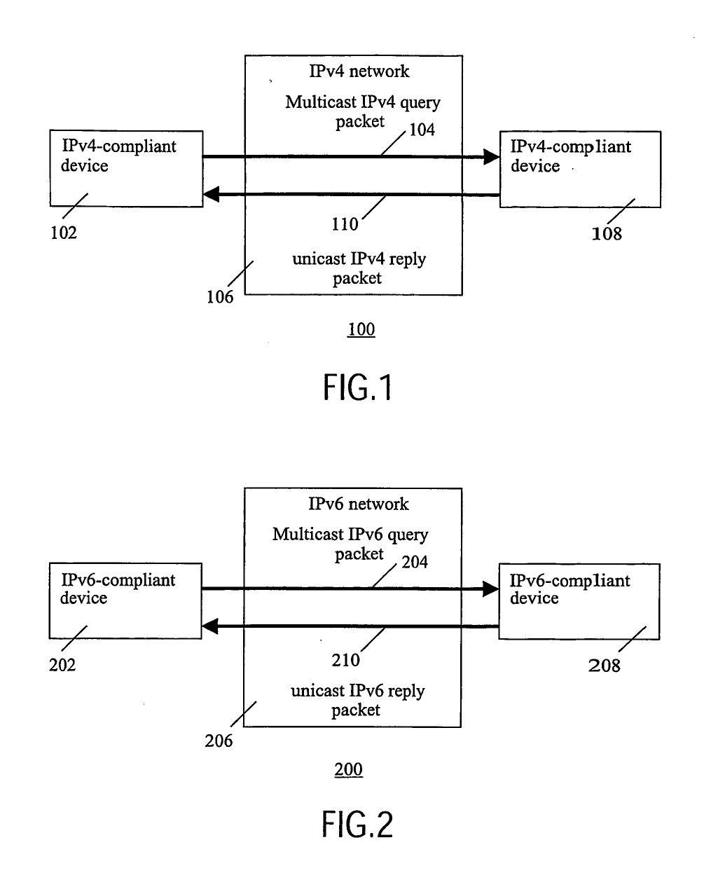

FIG. 1 is a diagram 100 illustrating a conventional multicast querying scenario on an IPv4 network. In diagram 100, IPv4-compliant device 102 multicasts an SDDP query packet 104 on an IPv4 network 106. Packet 104 is received by another IPv4-compliant device 108. According to the SSDP protocol, receiving device. 108 must respond to receiving of query packet 104. Accordingly, device 108 returns a unicast reply packet 110 via IPv4 network 106.

FIG. 2 is a diagram 200 illustrating a conventional multicast querying scenario on an IPv6 network. In diagram 200, IPv6-compliant device 202 multicasts an SDDP query packet 204 on an IPv6 network 206. Packet 204 is received by another IPv6-compliant device 208. According to the SSDP protocol, receiving device 208 must respond to receiving of query packet 204. Accordingly, device 208 returns a unicast reply packet 210 via IPv6 network 206.

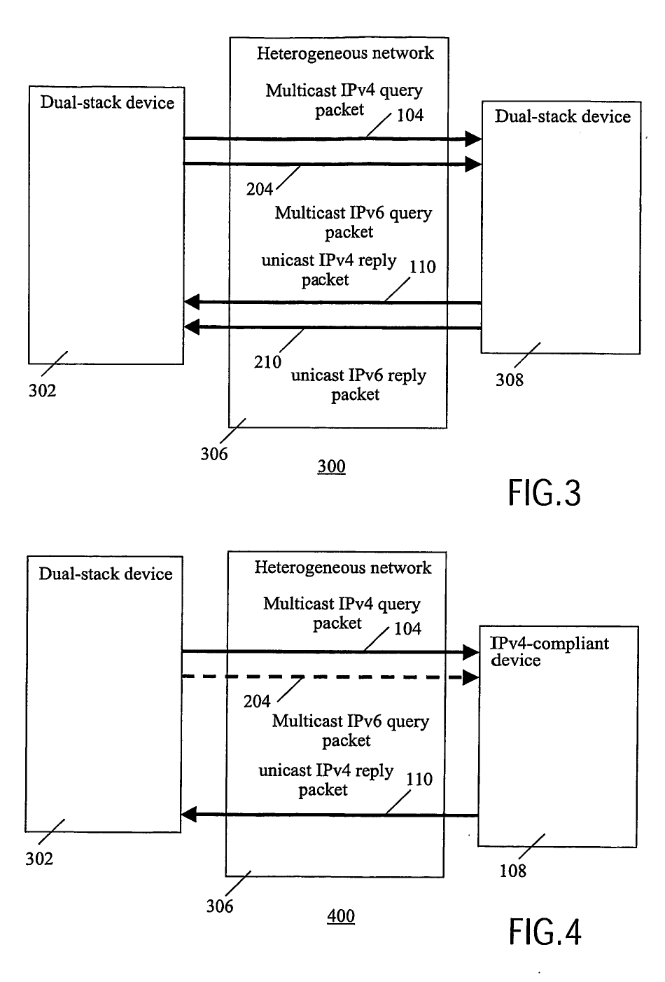

FIG. 3 is a diagram 300 illustrating a conventional multicast querying scenario on a heterogeneous network 304 supporting both IPv4 and IPv6. In diagram 300, dual-stack device 302 multicasts an SDDP IPv4 query packet 104 and an SDDP IPv6 query packet 204. Packet 104 is multicast on the logical part of network 306 that supports IPv4. Packet 204 is multicast on the logical part of network 306 that supports IPv6. Packets 104 and 204 are received by another dual-stack device 308. According to the SSDP protocol, receiving device 308 must respond to each query packet received. Accordingly, device 308 returns a unicast reply packet 110 using IPv4 and a unicast reply packet 210 using IPv6.

FIG. 4 is a diagram 400 illustrating interaction of dual-stack device 302 with IPv4-compliant device 108 via heterogeneous network 306. Device 302 multicasts IPv4 query packet 104 and IPv6 query packet 204. Device 108 is IPv4-compliant and ignores packet 204. Device 108 recognizes packet 104 and returns a unicast packet 110 via IPv4.

FIG. 5 is a diagram 500 illustrating interaction of dual-stack device 302 with IPv6-compliant device 208 via heterogeneous network 306. Device 302 multicasts IPv4 query packet 104 and IPv6 query packet 204. Device 208 is IPv6-compliant and ignores packet 104. Device 208 recognizes packet 204 and returns a unicast packet 210 via IPv6.

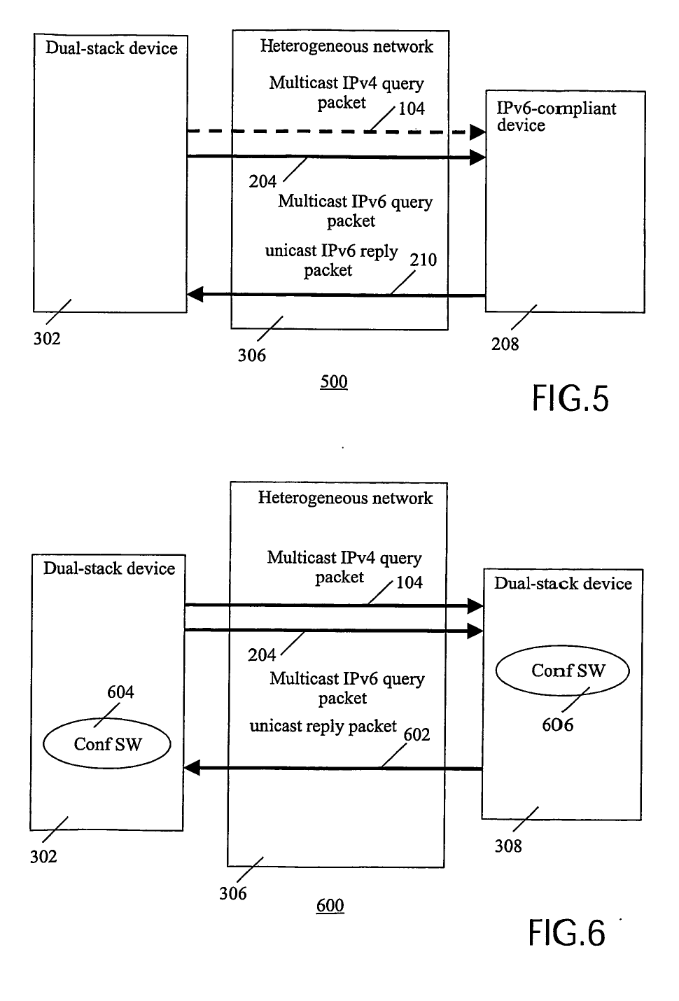

FIG. 6 is a diagram 600 illustrating a multicast querying scenario on a heterogeneous network 304 supporting both IPv4 and IPv6. In diagram 600, dual-stack device 302 multicasts an SDDP IPv4 query packet 104 and an SDDP IPv6 query packet 204. Packet 104 is multicast on the logical part of network 306 that supports IPv4. Packet 204 is multicast on the logical part of network 306 that supports IPv6. Packets 104 and 204 are received by another dual-stack device 308. According to the invention, packets 104 and 204 each comprise an indication that device 302 is a dual-stack device, i.e., a device that is capable of handling data communication according to both the IPv4 protocol and the IPv6 protocol. Receiving dual-stack device 308 now has multiple options to respond to query packets 104 and 204 by sending a unicast reply 602. A first option is to respond only to the instance of the query that arrives first through either IPv4 or IPv6. For example, if IPv4 query packet 104 is the first to be received, device 308 sends a unicast IPv4 reply 602, and if IPv6 query packet 204 is the first to be received, device 308 sends a unicast IPv6 reply 602. Alternatively, device 308 always sends an IPv6 reply packet 602 upon receiving the first one of packets 104 and 204. A second option is to ignore query packets from dual-stack devices, such as device 302, when received through IPv4, and await the IPv6 query packet. Device 308 then responds by unicast IPv6 reply packet 602.

Dual-stack devices 302 and 308 have been configured through configuration software 604 and 606, respectively, to implement the relevant instances of the invention. Software 604 was used for configuring device 302 that is operative to multicast on data network 306 respective query packets, 104 and 204, using respective ones of the multiple protocols, here IPv4 and IPv6, respectively. Software 604 is operative to configure device 302 for including in at least a specific one of respective query packets 104 and 204 an indication representative of the device supporting the multiple protocols as discussed above. Software 606 was used for configuring device 308 that supports multiple protocols: IPv4 and IPv6. Device 308 has an operational mode for receiving via network 306 query packets 104 and 204. At least a specific one of query packets 104 and 204, or both, includes an indication representative of the source, here device 302, of query packets 104 and 204 supporting the multiple protocols. Software 606 is operative to configure device 308 for responding via a single unicast reply packet 602 to only a single one of query packets 104 and 204 in dependence of the indication.

Software 604 and 606 may have been made available on an information carrier (not shown) for being plugged into the system, e.g., a home network, of diagram 600 for configuring devices 302 and 308 from a local source. Alternatively, software entities 604 and 606 may have been supplied by a service provider (not shown) via the Internet and a connection to network 306 (not shown) so as to enable remote control of the configuration without, or with minimum, user intervention.

1. An electronic device for use on a data network, wherein:
the network supports multiple data communication protocols;
the device has an operational mode for multicasting on the data network respective query packets using respective ones of the multiple protocols; and
at least a specific one of the respective query packets includes an indication representative of the device supporting the multiple protocols.

2. The device of claim 1, comprising a UPnP-compliant component for querying the network based on IP multicasting, wherein the protocols comprise IPv4 and IPv6 and wherein the component is configured to send the specific query packet with the indication that the component supports both IPv4 and IPv6.

3. The device of claim 2, wherein the specific query packet comprises an SSDP packet and wherein the indication is accommodated in an OPT field of the SSDP packet.

4. An electronic device for use on a data network that supports multiple data communication protocols, wherein:
the device supports the multiple protocols;
the device has an operational mode for receiving via the network respective query packets using respective ones of the multiple protocols;
at least a specific one of the query packets include an indication representative of a source of the query packets supporting the multiple protocols; and
the device responds to only a single one of the query packets using a single one of the protocols in dependence of the indication.

5. The device of claim 4, operative to respond to only the single query packet that is the first to arrive.

6. The device of claim 4, operative to respond to only the single query packet that uses a specific one of the protocols.

7. The device of claim 4, comprising a UPnP-compliant component, and wherein the protocols comprise IPv4 and IPv6.

8. The device of claim 7, operative to respond to only the query packet using IPv6.

9. Software for configuring an electronic device for use on a data network that supports multiple data communication protocols, wherein:
the device is configured for multicasting on the data network respective query packets using respective ones of the multiple protocols; and
the software is operative to configure the device for including in at least a specific one of the respective query packets an indication representative of the device supporting the multiple protocols.

10. The software of claim 9, wherein:
the device comprises a UPnP-compliant component for querying the network based on IP multicasting,
the protocols comprise IPv4 and IPv6; and
the software is operative to configure the component for sending the specific query packet with the indication that the component supports both IPv4 and IPv6.

11. The software of claim 10, wherein:
the specific query packet comprises an SSDP packet; and
the software configures the component so as to accommodate the indication in an OPT field of the SSDP packet.

12. Software for configuring an electronic device for use on a data network that supports multiple data communication protocols, wherein:
the device is configured to support the multiple protocols;
the device has an operational mode for receiving via the network respective query packets using respective ones of the multiple protocols;
at least a specific one of the query packets include an indication representative of a source of the query packets supporting the multiple protocols; and
the software is operative to configure the device for responding to only a single one of the query packets using a single one of the protocols in dependence of the indication.

13. The software of claim 12, operative to configure the device to respond to only the single query packet that is the first to arrive.

14. The software of claim 12, operative to configure the device to respond to only the single query packet that uses a specific one of the protocols.

15. The software of claim 12, wherein the device comprises a UPnP-compliant component, and wherein the protocols comprise IPv4 and IPv6.

16. The software of claim 15, operative to configure the device to respond to only the single query packet using IPv6.

17. A method of enabling to configure an electronic device for use on a data network that supports multiple data communication protocols, wherein:
the device is configured for multicasting on the data network respective query packets using respective ones of the multiple protocols; and
the method comprising enabling to configure the device for including in at least a specific one of the respective query packets an indication representative of the device supporting the multiple protocols.

18. The method of claim 17, wherein the device comprises a UPnP-compliant component for querying the network based on IP multicasting, wherein the protocols comprise IPv4 and IPv6 and wherein the method comprises enabling to configure the component to send the specific query packet with the indication that the component supports both IPv4 and IPv6.

19. The method of claim 18, wherein:
the specific query packet comprises an SSDP packet; and
the method comprises enabling to configure the component so as to accommodate the indication in an OPT field of the SSDP packet.

20. A method of enabling to configure an electronic device for use on a data network that supports multiple data communication protocols, wherein:
the device is configured to support the multiple protocols;
the device has an operational mode for receiving via the network respective query packets using respective ones of the multiple protocols;
at least a specific one of the query packets include an indication representative of a source of the query packets supporting the multiple protocols; and
the method comprises enabling to configure the device for responding to only a single one of the query packets using a single one of the protocols in dependence of the indication.

21. The method of claim 20, comprising enabling to configure the device to respond to only the single query packet that is the first to arrive.

22. The method of claim 20, comprising enabling to configure the device to respond to only the single query packet that uses a specific one of the protocols.

23. The method of claim 20, wherein the device comprises a UPnP-compliant component, and wherein the protocols comprise IPv4 and IPv6.

24. The method of claim 23, comprising enabling to configure the device to respond to only the single query packet using IPv6.
